(19) United States
(12) Patent Application Publication
(10) Pub. No.: US 2011/0164065 A1
(43) Pub. Date: Jul. 7, 2011

(54) Method And Apparatus For Configuring Display Bezel Compensation For A Single Large Surface Display Formed By A Plurality Of Displays

(75) Inventors: Elena Mate, Toronto (CA); Lawrence Kwak, Richmond Hill (CA)

(73) Assignee: ATI TECHNOLOGIES ULC, Markham, ON (CA)

(21) Appl. No.: 12/683,237

(22) Filed: Jan. 6, 2010

(51) Int. Cl. G09G 5/00; G06F 3/048

(52) U.S. Cl. 345/676; 715/769; 345/1.3

(57) ABSTRACT

A method includes displaying, on a single large surface display, a first moveable and second fixed portion of a visual test object. The first portion is displayed on the display to be configured and the second portion is displayed on at least one neighboring display, and are shown in a relative orientation adjacent to a common border formed by a first bezel of the display to be configured and a second bezel of the at least one neighboring display, and any space in between. The method obtains bezel compensation configuration information in response to input aligning the first portion with the second portion. A user may provide input by moving the first portion to align it with the second portion so that a third portion of the visual test object appears hidden by the common border. The object therefore appears aligned “behind” the bezel.

### FIELD OF THE DISCLOSURE

The present disclosure is related to systems having multiple displays wherein the multiple displays may be used to display a single image over the surface area of the combined displays, that is, to form a single large surface display, and to providing compensation for the bezels surrounding the borders of the individual displays forming the single large surface display.

### BACKGROUND

Various applications, such as gaming applications, may use multiple displays to increase the area over which visual information may be displayed. That is, a group of monitors may be arranged to form a single large surface that can display a partitioned image. The ability to drive multiple displays is beginning to allow a number of new display combinations. Such existing combinations include any combination of “cloned” displays, where more than one display shows the same desktop, and extended displays, where each display contains a different desktop. Other modes are also enabled by the driving of multiple displays, such as modes sometimes called “Very Large Desktop” (VLD), and Stretch mode or Span Mode. VLD for example, allows two or more displays to display a single desktop, and utilizes two or more GPUs coupled to the rendering ability of one GPU to drive the two or more displays (i.e. 4, 6, 8 or more). Stretch or Span Mode allows two displays to display a single desktop using a single GPU. Some existing products enable up to three displays to operate in concert.

Displays include an outer border, which is sometimes referred to as the display's bezel. When displays are arranged in a grid, the bezels form a spacing between the viewable areas of the displays, causing the grid of displays to appear similar to a window having window panes. When the display grid is used as a single large surface (SLS) display, the image portions displayed on each of the displays may not align properly to provide the desired appearance. That is, the multiple display images may not properly align to provide the appearance of a single image viewed through a large window, with the bezels appearing as the dividers between window panes. A portion of the image (that is, some of the SLS pixels) should appear to be hidden behind the bezels, but still aligned from one display to the other, in order to produce the desired effect.

It therefore becomes necessary to provide compensation for the spacing of the bezel, in order to achieve the desired continuity of the overall image. Existing systems provide the user with the capability of providing bezel compensation, but only for an n×1 or 2×2 display arrangement. These systems require the user to tinker with parameters contained in a settings file, and proceed by trial-and-error to find the parameter settings that align the images on the displays in order to compensate for the bezel spacing.

However, as the SLS is increased in size by using additional displays (e.g., more than a 2×2 grid) the complexity of the parameter adjustments needed to implement bezel compensation also increases and the trial-and-error tinkering approach becomes, not only extremely tedious and time-consuming, but almost impossible for an ordinary user to achieve. However currently, in order to implement bezel compensation, the user must tinker with parameter settings as mentioned above.

Therefore a need exists for methods and apparatuses to configure the bezel compensation for a group of displays participating in a single large surface.

### BRIEF DESCRIPTION OF THE DRAWINGS

FIG. 1 is a block diagram illustrating an apparatus in accordance with an embodiment, connected to a plurality of displays where the plurality of displays may form an arrangement.

FIG. 2 is a block diagram on an apparatus in accordance with an embodiment, where the apparatus supports connections to at least two sets of six displays, for a total of at least twelve displays, where the displays form a single large area (SLS) surface in a grid arrangement.

FIG. 3 illustrates a user interface window, which may be displayed on at least one display of the plurality of displays in an SLS, which allows designation of the SLS grid arrangement.

FIG. 4 illustrates a user interface window provided so that a user may enter physical position information of each display in an SLS display grid, so that the displays may be mapped to their logical position (i.e. the display grid coordinates) in the display grid arrangement.

FIG. 5 is a display grid information table illustrating mapping information that is created wherein the display corresponding to its display port number is mapped to the display's coordinate position in an SLS display grid. Image data portions stored by the frame buffer are mapped to display grid coordinate locations of the displays.

FIG. 6 illustrates a user interface window provided so that a user may proceed to configure bezel compensation for the SLS display grid, or otherwise proceed without bezel compensation.

FIG. 7 is a diagram of an SLS display grid having twelve displays arranged in three rows of four columns, and shows an example of the general direction of the process flow of configuring bezel compensation in accordance with an embodiment.

FIG. 8 illustrates how a geometric shape, such as a right triangle or other appropriate shape, may be used in some embodiments as a visual aid for configuring bezel compensation. Also shown are the control buttons that are provided to align the geometric shape in accordance with some embodiments.

FIG. 9 shows further details of the control buttons illustrated in FIG. 8, in accordance with some embodiments.

FIG. 10 illustrates an example step in the bezel compensation process where bezel compensation for one of the displays, corresponding to grid coordinate (1, 3), may be configured in accordance with some embodiments.

FIG. 11 illustrates an example step in the bezel compensation process where bezel compensation for one of the displays, corresponding to grid coordinate (2,1), may be configured in accordance with some embodiments.

FIG. 12 illustrates an example step in the bezel compensation process where bezel compensation for one of the displays, corresponding to grid coordinate (1,1), may be configured in accordance with some embodiments.

FIG. 13 illustrates an example step in the bezel compensation process where bezel compensation for one of the displays, corresponding to grid coordinate (1,2), may be configured in accordance with some embodiments.

FIG. 14 illustrates a bezel configuration confirmation view where a plurality of visual test objects are shown so that the user can determine if bezel configuration for the SLS is completed.

FIG. 15 is a flowchart illustrating an operation of the various embodiments.

FIG. 16 is a flowchart illustrating operation of one embodiment in which a reference display's logical vertical and horizontal coordinates are fixed and are then afterwards not configurable by the user.

FIG. 17 is a flowchart illustrating operation of the various embodiment for accomplishing bezel configuration for an SLS display having N displays.

FIG. 18 is a flowchart illustrating operation of another embodiment in which logical coordinates of some displays of and SLS are fixed and define horizontal and/or vertical boundaries such that configuration procedures are reduced and thereby also simplified.

### DETAILED DESCRIPTION

The present disclosure provides methods and apparatuses for configuring bezel compensation for a plurality of displays forming a Single Large Surface (SLS) display grid. The disclosed embodiments proved an intuitive and easy to use user interface that shows a geometric shape, or other appropriate image, on the display to be configured, with a portion of the geometric shape extending “underneath” the bezel area with a portion of the shape displayed on a neighboring display. The user may align and position the geometric images along the bezels by using, in some embodiments, a set of control buttons that enable positioning and aligning of the geometric shape. The related apparatuses include the capability to drive multiple displays, for example five, six, seven, twelve, twenty-four, etc., or more independent displays, which may be arranged in various row and column combinations to form SLS display grids. Each display of the SLS display grid may provide an integer fraction of an overall desktop size. In one example, each of 4 displays may each provide 1920×1200 pixel resolution which is then arranged as a 2×2 grid which displays a 3840×2400 desktop. Another arrangement may be a 4×1 grid which leads to a 7680×1200 desktop. Although the exemplary embodiments disclosed herein involve a rectangular grid for simplicity of explanation, other implementations are possible in accordance with the embodiments. Other exemplary display arrangements that may be obtained in accordance with the embodiments include, but are not limited to: 1 wide by 3 high, 2 wide by 2 high, and 3 wide by 2 high. That is, the embodiments support a number of arrangements including various single row, and multiple row topologies (not all topologies including the same number of displays in the rows and/or columns of the grid).

The various embodiments disclosed herein include a method that includes displaying, on a display to be configured and on at least one neighboring display of a plurality of displays forming a single large surface display, a visual test object that is separated into a first portion and a second portion. The first portion is displayed on the display to be configured and the second portion is displayed on the at least one neighboring display, and are shown in a relative orientation adjacent to a common border, between the display to be configured and the at least one neighboring display. The common border is formed by a first bezel of the display to be configured and a second bezel of the at least one neighboring display, and space in between. The method further includes obtaining bezel compensation configuration information in response to input aligning the first portion with the second portion. The first portion is moveable and the second portion is fixed, and therefore a user may provide input by moving the first portion to align it with the second portion so that a third portion of the visual test object appears hidden by the common border. The object therefore appears aligned “behind” the bezel and any spacing with respect to the user's visual perception of the object.

The method may also include displaying an alignment control for aligning the first portion with the second portion, and adjusting relative vertical and horizontal logical coordinates of the display to be configured's viewable area based on the bezel compensation configuration information, and in response to the first portion of the visual test object being moved using the alignment control. In one embodiment, the alignment control may include moving the object by using a drag-and-drop technique.

In some embodiments, the visual test object may be right triangle, which further in some embodiments may have a fill color and may be displayed on a black (or other suitable dark color) background in order to enhance the user's perception of alignment and to avoid problems due to the well known Poggendorff illusion.

The method may further include obtaining, as input, approximate width and height dimensions of the single large area surface (SLS) display to be formed by the plurality of displays, obtaining, as input, approximate height and width dimensions of total bezel heights and widths for the plurality of displays, and fixing vertical and horizontal logical coordinates of at least one reference display within the SLS display based on the approximate width and height dimensions. The approximate height and width dimensions of total bezel heights and widths for the plurality of displays may also include any spaces between bezels of neighboring displays within the single large area surface display.

In one embodiment, the method includes fixing vertical and horizontal coordinates of a reference display in a corner of a rectangular arrangement wherein the plurality of displays forming the SLS display are arranged in the rectangular arrangement. Any suitable corner may be selected as the reference point in the various embodiments, such as the upper top left corner, the bottom right corner, etc.

In addition, the method of some embodiments includes determining a set of displays to be configured selected from the plurality of displays forming the SLS display, and displaying one or more visual test objects, on each display to be configured of the set of displays, for each display to be configured one-by-one, sequentially proceeding in a sequence to a next display to be configured after completion of configuration of a previous display to be configured, wherein the sequence follows an approximately spiral pattern proceeding from a display at an outer perimeter of the rectangular arrangement to a final innermost display that is innermost of the rectangular arrangement. Among other advantages, this method allows some perimeters to be fixed to reduce the overall configuration input required for configuring a large SLS display.

In another embodiment, a method includes obtaining approximate width and height dimensions of a single large area surface display to be formed by a plurality of displays, obtaining approximate height and width dimensions of the total bezel heights and widths for the plurality of displays, providing, by bezel compensation configuration logic, displayable information to a display to be configured and to at least one neighboring display of the plurality of displays forming the single large surface display, wherein the displayable information is for displaying a visual test object that is separated into a first portion and a second portion, wherein the first portion is to be displayed on the display to be configured and wherein the second portion is to be displayed on the at least one neighboring display, and wherein the first portion and the second portion are to be displayed in a relative orientation across a border formed by a first bezel of the display to be configured and a second bezel of the at least one neighboring display, and obtaining configuration information based on input aligning the first portion with the second portion.

The disclosed embodiments also provide an apparatus that is capable of performing the above described methods. For example, one embodiment of an apparatus is disclosed that comprises a plurality of display connection ports operably connectable to a plurality of displays; at least one programmable processor operatively coupled to the plurality of display connection ports; and memory operatively coupled to the programmable processor, wherein the memory contains executable instructions for execution by the at least one processor. The at least one programmable processor, upon executing the executable instructions is operable to provide displayable information to a display to be configured and to at least one neighboring display of a plurality of displays forming a single large surface display, the displayable information including a visual test object that is separated into a first portion and a second portion, wherein the first portion is for display on the display to be configured and wherein the second portion is for display on the at least one neighboring display, and wherein the first portion and the second portion are displayed in a relative orientation adjacent to a common border, between the display to be configured and the at least one neighboring display, the common border formed by a first bezel of the display to be configured and a second bezel of the at least one neighboring display. Further the programmable processor is operative to obtain bezel compensation configuration information in response to input aligning the first portion with the second portion, wherein the first portion displayed on the display to be configured is moveable and the second portion is fixed, and wherein the first portion is moved to align the first portion with the second portion so that a third portion of the visual test object appears hidden by the common border.

The apparatus' at least one programmable processor, may also be operable to provide displayable information for displaying an alignment control for aligning the first portion with the second portion; and adjust relative vertical and horizontal logical coordinates of the display to be configured's viewable area based on the bezel compensation configuration information, and in response to the first portion of the visual test object being moved using the alignment control.

The apparatus disclosed may further comprise a plurality of displays, each display connected to a corresponding display connection port of the plurality of display connection ports, where the plurality of displays are thus operatively coupled to the at least one processor. The plurality of displays are operative to display, on the display to be configured and on the at least one neighboring display of the plurality of displays forming a single large surface display, the visual test object, in response to the displayable information.

In some embodiments, the apparatus' at least one programmable processor, upon executing the executable instructions is also operable to adjust relative vertical and horizontal logical coordinates of the display to be configured's viewable area based on the bezel compensation configuration information, and in response to the first portion of the visual test object being moved using a drag-and-drop technique. The at least one programmable processor may also provide displayable information to the plurality of displays for displaying a right triangle as the visual test object. The right triangle may have a colored fill and may be displayed on a black background on the display to be configured and on the at least one neighboring display as discussed above with respect to the methods of operation.

The apparatus' at least one programmable processor, may further in some embodiments obtain, as input, approximate width and height dimensions of the single large area surface (SLS) display to be formed by the plurality of displays; obtain, as input, approximate height and width dimensions of total bezel heights and widths for the plurality of displays; and fix vertical and horizontal logical coordinates of at least one reference display within the SLS display based on the approximate width and height dimensions. Total bezel heights and widths may include any spaces between bezels of neighboring displays within the single large area surface display.

In one embodiment, the apparatus' at least one programmable processor, upon executing the executable instructions is operable to fix the vertical and horizontal logical coordinates of at least one reference display within the SLS display based on the approximate width and height dimensions, by fixing vertical and horizontal coordinates of a reference display in a corner of a rectangular arrangement wherein the plurality of displays forming the SLS display are arranged in the rectangular arrangement.

The apparatus' at least one programmable processor may also determine a set of displays to be configured selected from the plurality of displays forming the SLS display, and provide displayable information for displaying one or more visual test objects, on each display to be configured of the set of displays, for each display to be configured one-by-one, sequentially proceeding in a sequence to a next display to be configured after completion of configuration of a previous display to be configured, wherein the sequence follows an approximately spiral pattern proceeding from a display at an outer perimeter of the rectangular arrangement to a final innermost display that is innermost of the rectangular arrangement.

The embodiments herein disclosed also include a computer readable memory storing executable instructions for execution by at least one processor, that when executed cause the at least one processor to perform all of the methods of operation as outlined above. The computer readable medium may be any suitable computer readable medium such as, but not limited to, a server memory, CD, DVD, hard disk drive, flash ROM (including a “thumb drive”) or other non-volatile memory that may store and provide code to be executed by one or more processors.

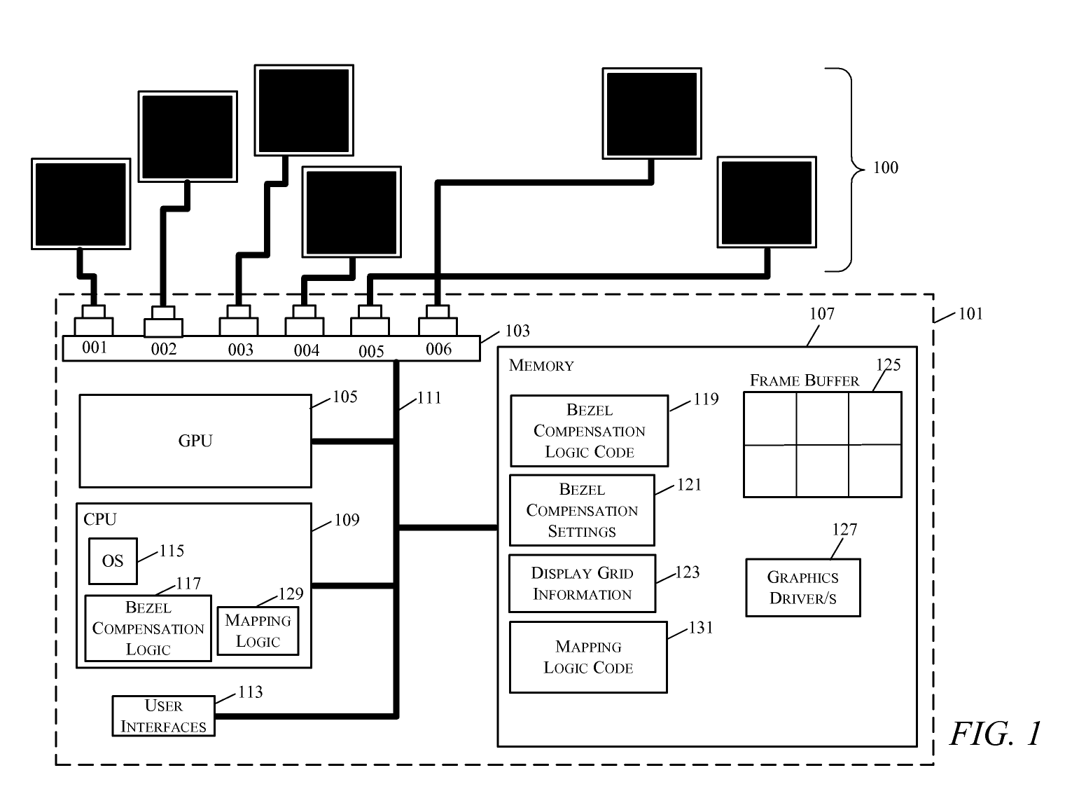

Turning now to the drawings wherein like numerals represent like components, FIG. 1 is a block diagram of an apparatus connected to a plurality of displays in accordance with the various embodiments. In the exemplary embodiment illustrated in FIG. 1, the plurality of displays 100 includes six displays. A set of connector ports 103 includes six connectors labeled 001 thru 006. As will be described in further detail, the plurality of displays 100 may be arranged in a rectangular arrangement.

The displays illustrated in FIG. 1, may be considered as being associated with their respective connector port numbers which correspond to the set of connector ports 103. For example as shown in FIG. 1, one display is shown connected to port 001, another display is connected to connector port 002, etc. Although, in the exemplary embodiment shown in FIG. 1, the plurality of displays 100 is connected to the set of connector ports 103 via cabling, the set of connector ports 103 may also be wireless. Therefore, in some embodiments, the plurality of displays 100 may be wirelessly connected to a set of wireless connector ports. Further, in other embodiments, the plurality of displays 100 may be connected by a combination of wired/cable and wireless connection ports. Therefore the set of connector ports 103 may, in the various embodiments, be cable type connectors, wireless connectors, or a combination of cable and wireless connectors. In still other embodiments, some, or all, displays of the plurality of displays 100 may be “daisy-chained” such that only one or two displays of a daisy-chain is connected directly to the set of connector ports 103. In the embodiments employing daisy-chained displays, the displays are still assigned a logical port number which corresponds to an initial expected position. These initial expected positions (or logical port numbers) are initially mapped to image data portions of a frame buffer (corresponding to logical coordinates of a display grid arrangement) as is described further below. That is, the logical port numbers may be used to create a default mapping (initial mapping or initial expected positions) of image data portions to each connected display.

The set of connector ports 103 is shown included in the apparatus 101, which may be a single multi-layer PC board in some embodiments. In other embodiments, the apparatus 101 may be a computer system consisting of multiple PC boards such as a graphics processing card and a mother board which includes the central processing unit 109. However, in other embodiments, the apparatus 101 may be an integrated single PC board that includes both the central processing unit 109 and the graphics processing unit 105. Further, the CPU 109 and GPU 105 may each include one or more processing cores and may be physically located on separate integrated circuits, or on a single integrated circuit die. In some embodiments, the CPU 109 and GPU 105 may be located on separate printed circuit boards within apparatus 101. Also in some embodiments, multiple CPUs and/or GPUs may be operatively coupled to each other and to multiple sets of connector ports 103. Memory 107 is a representation of system memory which may be in any suitable location within the apparatus 101.

Other necessary components, as understood by those of ordinary skill, may also be present within the apparatus 101. Therefore, it is to be understood that, in addition to the items shown which are shown for the purpose of explaining to those of ordinary skill how to make and use the various embodiments herein disclosed, other components may be present as would be required and as would be understood by one of ordinary skill to be present such that the apparatus 101 will be a fully functional apparatus. For example, a memory controller may be present and may interface between, for example, the central processing unit 109 and memory 107. However such additional components are not shown as they are not necessary for providing an understanding of the presently disclosed embodiments.

Therefore in accordance with an embodiment, the apparatus 101 includes at least central processing unit 109, the graphics processing unit 105 and memory 107, all of which are operatively coupled by a communication bus 111. As discussed above with respect to apparatus 101, internal components, such as, but not limited to, the communication bus 111, may include other components which are not shown but would be necessary to the operation of the apparatus 101 as would be understood by those of ordinary skill. The plurality of display ports 103 is also operatively connected to the communication bus 111 and is therefore also operatively connected to the central processing unit 109, the graphics processing unit 105 and the memory 107. The memory 107 includes a frame buffer 125. The frame buffer 125 may alternatively in some embodiments be included in a dedicated memory of GPU 105, or in yet another alternative embodiment, may be distributed between system memory 107 and GPU 105 dedicated memory.

As shown in FIG. 1, the frame buffer 125 is partitioned into a set of image data portions corresponding to the arrangement of the SLS display grid. For example, as shown, the frame buffer 125 is partitioned to include six image data portions, in a two row by three column grid arrangement, such that each image data portion corresponds to a physical display. The exemplary six image data portions may be considered as corresponding to the image portions viewed through windowpanes of a large rectangular window. The rectangular arrangement of the frame buffer 125 is set up to correspond with the physical arrangement of the plurality of displays 100 that is initially expected, for example, a default arrangement. This initially expected arrangement, or default arrangement, and the corresponding initial mapping of displays to the frame buffer, may be based on, for example, the logical designations of the physical ports to which each of the plurality of displays 100 is connected. As discussed above, some embodiments may employ daisy-chained displays in which case such daisy-chained displays will likewise have “initially expected” logical positions that are similarly initially mapped to the frame buffer 125. In other words, when a group of displays is initially connected, via any suitable means, (cables, wireless ports, daisy-chaining, or combinations thereof), each display is initially mapped to an image data portion of the frame buffer. This mapping may be considered a default mapping based simply on the physical connections. However, if the displays are arranged in an order that differs from the expected or default order, the image displayed by the group will appear out of order and therefore will appear scrambled. The user may then therefore perform a configuration operation, in accordance with the embodiments, to correct the mapping of the frame buffer to match the actual physical arrangement of the plurality of displays 100 forming the SLS display grid and thereby unscramble the displayed image. Of course, such a scrambled image need not be initially actually displayed. However imagining the appearance of such a scrambled image is helpful toward understanding the operation of the various embodiments. The mapping information is stored as display grid information 123, in memory 107, and is accessible by bezel compensation logic 117 as will be described in further detail below.

In accordance with the embodiments, the display grid information 123 is used by the central processing unit 109, and/or the graphics processing unit 105, to correctly display the logical image data portions of the frame buffer 125 on the correct displays of the plurality of displays 100 with respect to the displays' actual physical location, i.e., each display's logical coordinates within the SLS display grid arrangement. In accordance with the embodiments, mapping logic 129 provides a user interface and obtains user data so that the mapping of the displays' physical positions (SLS display grid coordinates) to the frame buffer may be accomplished to create mapping information within display grid information 123. In some embodiments, the mapping logic 129 may also use the mapping logic code 131. That is, the central processing unit 109 may execute the mapping logic code 131 (as executable instructions) from the memory 107 in some embodiments. In other embodiments the mapping logic 129 may operate independently, that is, without any mapping logic code 131.

The term “logic” as used herein may include software and/or firmware executing on one or more programmable processors (including CPUs and/or GPUs), and may also include ASICs, DSPs, hardwired logic or combinations thereof. Therefore, in accordance with the embodiments, the mapping logic and/or bezel compensation logic may be implemented in any appropriate fashion and would remain in accordance with the embodiments herein disclosed. The term “display” as used herein refers to a device (i.e. a monitor) that displays an image or images, such as, but not limited to, a picture, a computer desktop, a gaming background, a video, an application window etc. The term “image” as used herein refers generally to what is “displayed” on a display (such as a monitor) and includes, but is not limited to, a computer desktop, a gaming background, a video, an application window etc. An “image data portion” as used herein refers to, for example, a logical partition of an image that may be mapped to at least one display of a plurality of displays. The mapping of image data portions to displays within an arrangement of a plurality of displays enables the plurality of displays to act in concert as an SLS display.

After the displays are mapped to SLS grid coordinates, (and also to the image data portions of the frame buffer 125), the SLS display grid is ready to be configured for bezel compensation. In accordance with the embodiments, bezel compensation logic 117 provides a user interface or “bezel configuration wizard” to enable a user to proceed to adjust the displays in order to compensate for the bezels, and also any physical spacing, between the viewable surface areas of the displays forming the SLS display grid. The bezel configuration wizard may include one or more application windows that guide a user through the bezel configuration process. In some embodiments the bezel compensation logic 117 may be integrated with the mapping logic 129. Likewise, the bezel compensation code 119 may be integrated with the mapping logic code 131. In some embodiments, the bezel compensation logic 117 may use the bezel compensation logic code 119. That is, the central processing unit 109 may execute the bezel compensation logic code 119 (as executable instructions) from the memory 107 in some embodiments. In other embodiments the bezel compensation logic 117 may operate independently, that is, without any bezel compensation logic code 119. The bezel compensation logic 117 will initially communicate, via the operating system (OS) 115, with graphic driver/s 127 to determine whether the various displays making up the SLS display are “bezel-compensatable.” That is, the driver/s 127 will examine the physical capabilities of the displays, such as for example, but not limited to, a display's pixel density. The bezel compensation logic 117 obtains this information from the driver/s 127 and will enable bezel compensation configuration only for those displays of the SLS that are suitable for bezel compensation.

The bezel compensation logic 117 obtains input from the user interfaces 113, which include any suitable user interface such as, but not limited to, a keyboard, mouse, microphone, gyroscopic mouse, or soft controls displayed on a graphical user interface (GUI) displayed on one or more of the displays, etc. The bezel compensation logic 117 communicates with the OS 115 (operating system) and interfaces with one or more graphics drivers 127 via the OS 115. The graphic driver/s 127 may be executed by the CPU 109, GPU 105 or may involve some combination of operations by both the CPU and GPU. The graphics driver/s 127 are capable of driving the multiple displays, such as plurality of displays 100, to form an SLS display grid.

The bezel compensation logic 117 may be considered as providing “displayable information” to the displays via the OS 115 and graphics driver/s 127, in that, for example, visual test objects are displayed as determined by the bezel compensation logic 117. The displayable information is therefore information that is output to the displays and that the displays utilize to display graphical user interfaces (GUIs), visual test objects, control buttons, etc. The visual test objects may be, for example, a geometric shape, (2-dimensional or 3-dimensional), or a graphical representation of a physical object (such as a table, chair, tree, etc.), a character (such as a game avatar, etc.).

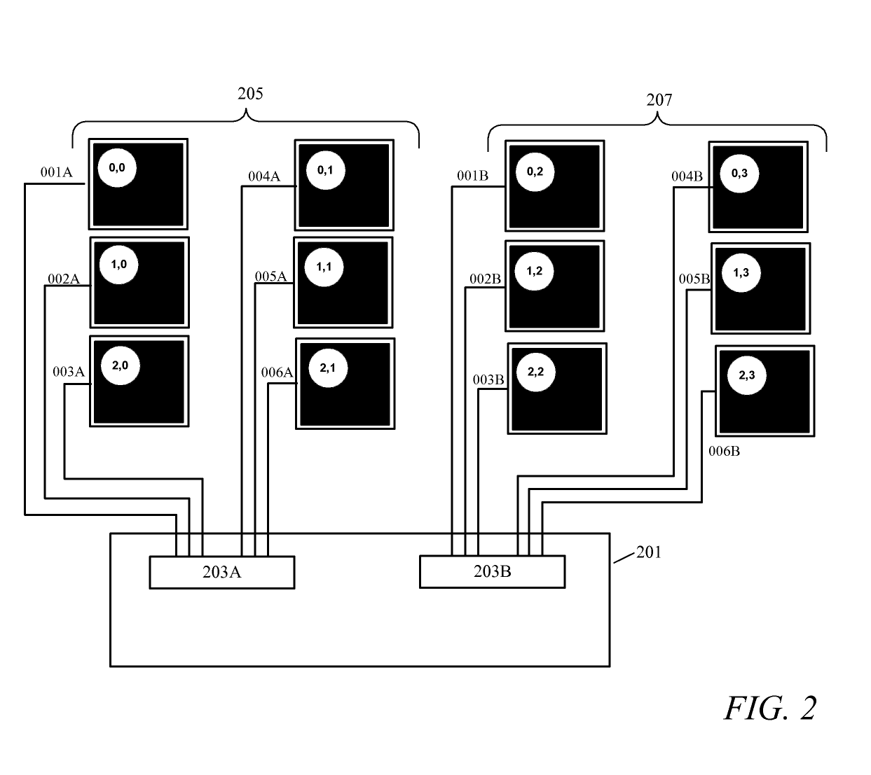

FIG. 2 illustrates another exemplary embodiment of an apparatus 201, which is capable of driving two sets of six displays, set 205 and set 207. The two sets of displays are each connected to corresponding sets of display connector ports. That is, display set 205 is connected to display connector ports 203A while display set 207 is connected to display connector ports 203B. The apparatus 201 includes the internal components as described with respect to apparatus 101 in FIG. 1, but includes additional components such as a second set of connector ports 203B, and also in some embodiments an associated additional GPU and/or CPU, etc.

In one example, the apparatus 201 may be a computer that includes multiple graphics processing units. The graphics processing units may be on a single PC board or may be each on their own individual graphics processing card where the graphics processing cards communicate by a communication bus. Regardless of the physical arrangement of the graphics processing units, the bezel configuration logic 117 operates in a similar way as will be described below.

In the exemplary embodiment illustrated in FIG. 2, the twelve displays are used to form an SLS display grid having three rows and four columns, (i.e. a 3×4 grid), where each display is associated with a logical coordinate, for example x-y coordinates beginning with row 0 and column 0, (grid coordinate (0,0)) through row 3 and column 4 (grid coordinate (2,3)). Exemplary logical SLS display grid coordinates are shown in circles in the upper left hand corner of each display illustrated in FIG. 2 for purposes of illustration. The displays are also associated with their respective display connector ports as was discussed previously. For example, the upper left hand corner display has logical SLS grid coordinates (0,0) and is associated with its connector port “001A” which is the first connector port of connector port set 203A as illustrated. The exemplary SLS grid illustrated in FIG. 2 will be utilized to further describe bezel compensation configuration in accordance with the various embodiments. However, it is to be understood that any number of displays could be used in an SLS and would benefit from the features of the methods and apparatuses herein described. That is, bezel compensation may be configured for an SLS display grid with any configuration and with any number of displays in accordance with the embodiments described herein.

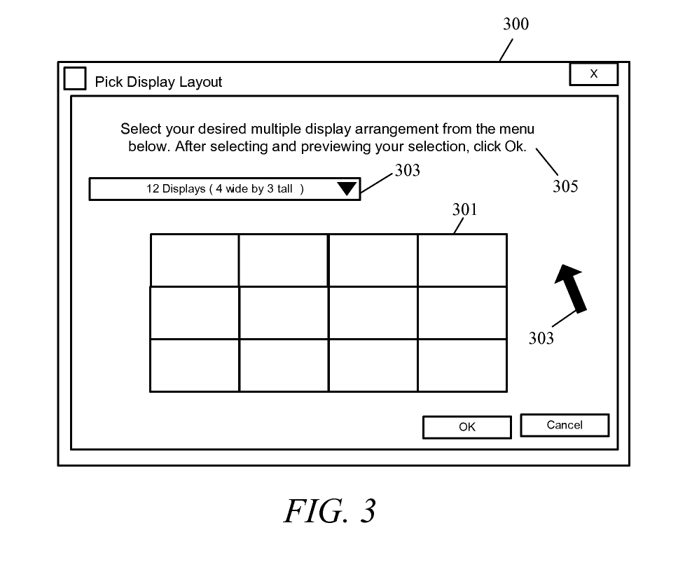

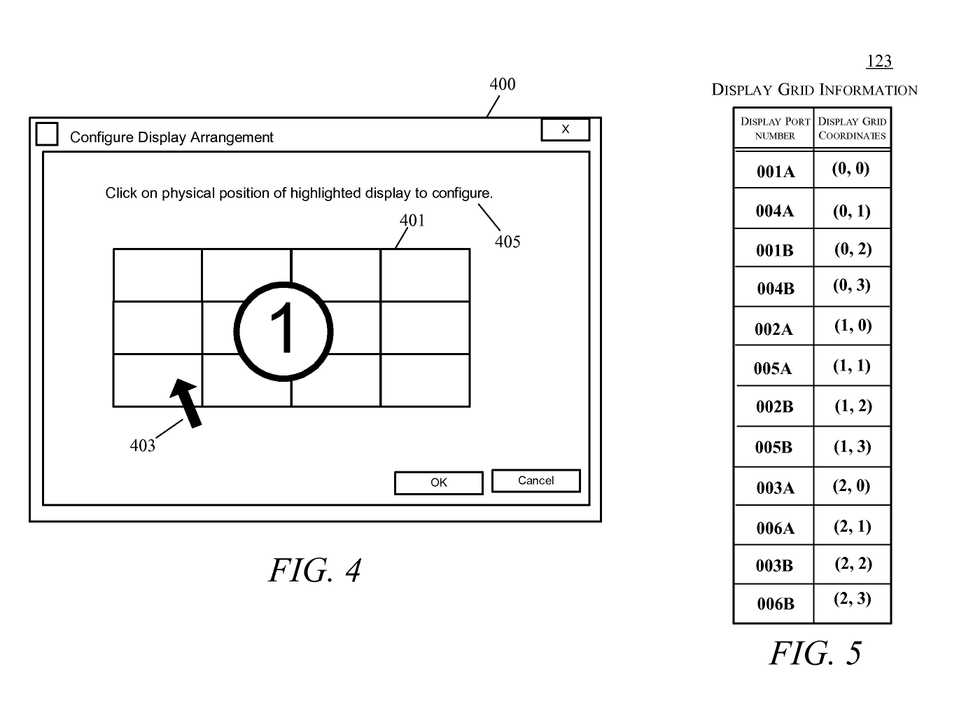

FIG. 3 illustrates an SLS configuration application window 300 that may be provided by the mapping logic 129 previously discussed. A user may, for example, receive the notification message 305 and may use a mouse cursor 303 to select a desired SLS configuration from a pull-down menu 303. For example, the user may select a twelve display configuration with “4 wide by 3 tall” as shown. The window 300 may then display a representation of the selected SLS grid 301. The user may then click “OK” to proceed.

A display configuration window 400 may then be displayed. The user may receive an appropriate visual indication on each display, (i.e. a highlighted display, lit display, etc.), and then use the mouse cursor 403 to indicate where in the SLS grid arrangement the display is actually located. The mapping logic 129 will obtain the user provided information to create a mapping as shown in FIG. 5 as display grid information table 123. As shown in FIG. 5, each of the displays is associated with a display connector port, which is mapped to, or associated with, a corresponding SLS display grid coordinate. The mapping logic is thereby able to further map the frame buffer image data portions to the appropriate display.

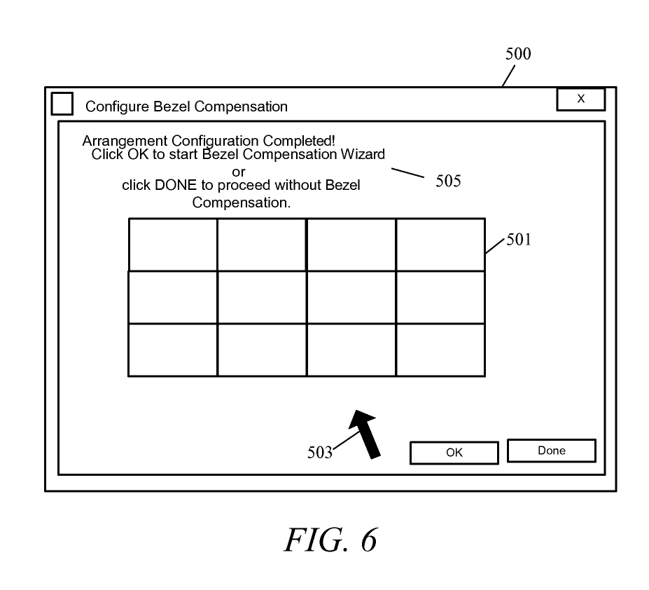

After the SLS display grid is configured and the display grid information 123 is created, the SLS displays may be configured for bezel compensation. FIG. 6 illustrates an exemplary bezel compensation configuration window 500 that may be displayed in accordance with the embodiments. The window 500 may include text 505 that notifies the user that arrangement configuration has been completed and that bezel compensation may now be configured, for example, by starting a “bezel compensation wizard.” The user may select “OK” to proceed with bezel compensation. Otherwise the user may also be able to proceed without any bezel compensation, by, for example, selecting “Done.”

It is to be understood that the various user interfaces and user interface windows illustrated and described are exemplary only and are for the purpose of describing operation of the various embodiments. Therefore other user interface windows etc., may be used that are arranged in various ways different from what is shown in the examples presented herein, and such other user interfaces still remain in accordance with the herein described embodiments.

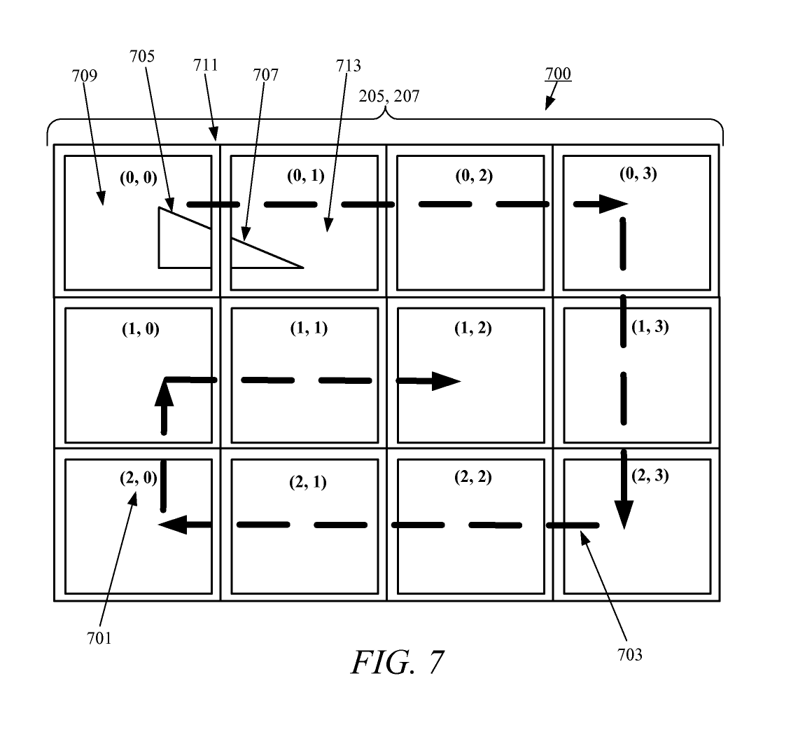

FIG. 7 illustrates the two sets of displays 205 and 207 forming an SLS display grid 700. Each of the displays is associated with a corresponding SLS display grid coordinate 701 as was discussed previously, and these coordinates 701 are shown within each display for purposes of explanation. In accordance with the embodiments, a bezel configuration process, which may be performed by using a “bezel configuration wizard” as was discussed above, follows a path through the SLS display grid in a manner similar to (but not necessarily exactly like) the path indicated by path indication arrows 703. In other words, the configuration path through the rectangular arrangement of displays will follow a generally spiral pattern. The spiral pattern begins at an outer perimeter of the rectangular arrangement and works inwardly toward the center of the display arrangement. This will be best understood by an exemplary specific embodiment which will be described below.

FIG. 7 also illustrates that the embodiments display a visual test object, such as, but not limited to, a geometric shape, such as, but not limited to, a triangle, on the viewable area 713 of the display to be configured (for example display (0, 1), and also on the necessary neighboring displays. For example displays (0, 0) (0, 2) and (1, 1) may be considered as “neighboring displays” of display (0, 1). However, only necessary neighbor displays will show the test object in accordance with the embodiments, that is, only certain neighboring displays may need to be used as configuration references as will be described in further detail. That is, the visual test object will be displayed on a display to be configured, and on at least one neighboring display. Where the display to be configured must be adjusted with respect to more than one neighboring display, a test object corresponding to each neighboring display will be shown. The visual test object geometric shape is shown partially hidden behind the bezel portion 711 of the displays. For example, in FIG. 7, a first portion of a right triangle 705 is displayed on display (0,0) and a second portion of the right triangle 707 is displayed on display (0,1). As can be seen in FIG. 7, a portion of the triangle is “hidden” behind the bezel portion 711. It is to be understood that the bezel portion 711 may also include a spacing between bezels of the neighboring displays. That is, although the display bezels in FIG. 7 are shown abutted upon each other, there may also be a space between the neighboring display bezels. The bezel compensation method of the embodiments also accounts for any such spacing between bezels.

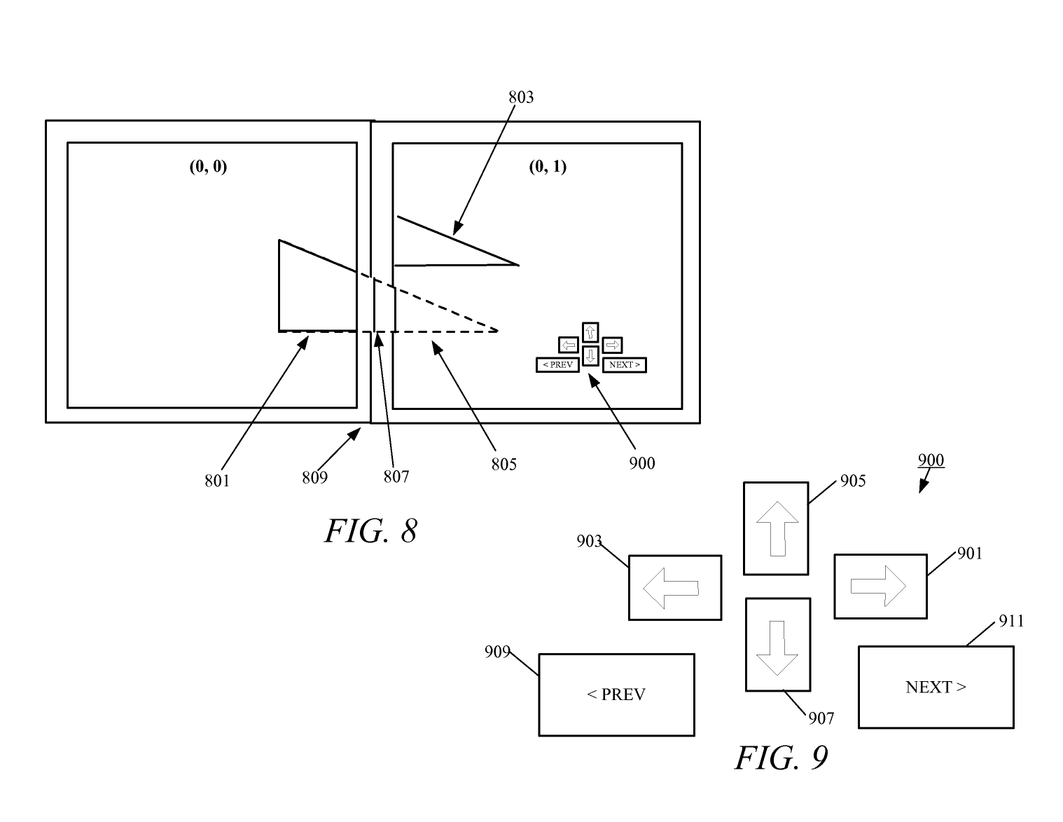

FIG. 8 illustrates further details of how the bezel compensation configuration is accomplished for a particular display in some embodiments. In FIG. 8, only displays (0,0) and (0,1) are shown, that is, a portion of the SLS display grid 700. When display (0,1) is to be configured for bezel compensation, a set of control buttons 900 appears on the viewable area of display (0,1) in some embodiments. In addition, one or more portions of a geometric shape, such as right triangle portion 803, also appears. The neighboring display, or displays, show corresponding fixed portions of the geometric shape, such as fixed right triangle portion 801. The user configures the display's bezel compensation by operating the control buttons 900 to move the right triangle portion 803 into alignment with the fixed right triangle portion 801. The dotted line portion 805 is provided in FIG. 9 for purpose of explanation to show that the entire right triangle extends across, and “behind” the bezel portion 809. That is, a first portion 803 is moveable, a second portion 801 is fixed, and a third portion 807, is hidden behind the bezel portion 809. The user must align the triangle portion 803 to coincide with the illustrative dotted line portion 805 such that the triangle appears to be continuous between display (0,0) and display (0,1) and across the bezel portion. The user may operate the control buttons 900 as shown in FIG. 9, to move the geometric shape upward, downward, right or left, by selecting the up control 905, down control 907, right control 901 or left control 903, respectively. In some embodiments however, some directions on the control buttons 900 may be disabled, for example shown “grayed-out” to indicate that these buttons are inactive. This is because, for example, a set of displays along an outer perimeter row or column of the SLS may be “fixed” with respect to one coordinate, such that an outer edge of the display is defined. In a specific example, the entire upper row from display (0, 0) to display (0, 3) may be fixed with respect to their logical vertical coordinates (i.e. y-coordinates) since this row of displays defines the top horizontal edge of the SLS. In this case, the upward control 905 and downward control 907 may be inactivated for configuration of display (0, 1) such that the visual test object 803 may only be moved right or left horizontally, and with respect to neighboring display (0, 0). Other rules that impact how the visual test object 803 may move may also be present in the embodiments. For example, the visual test object 803 is not allowed to move farther than a predetermined expected boundary area. That is, the bezel configuration logic 117 will begin the bezel configuration process with some predetermined inputs, such as an expected bezel area (i.e. total bezel widths and heights). One exemplary value for this expected bezel area may be 10% of a total desktop size (i.e. the single large desktop that is shown on the SLS display) where the desktop size is measure in pixel height and pixel width. If the visual test object 803 is moved too far in any given direction, based on the expected bezel area, the direction control for that direction will be grayed-out, that is, disabled. The user is however able to “bring back” the visual test object in the opposite direction to re-enable the direction control. After the bezel compensation configuration is completed for a specific display, the user may proceed to the next display by selecting the NEXT control 911 or may return to a previously configured display by selecting the “PREV” control 909. In an alternative embodiment the user may position the geometric object by using the mouse cursor to drag-and-drop the geometric object into position. In yet another alternative embodiment the user may position the geometric object by using the mouse cursor to drag-and-drop the geometric object into an initial position, and subsequently use the control buttons 900 to make fine adjustments to the position. The keyboard cursor keys, or other keyboard shortcuts may also be used to move the visual text object in accordance with the embodiments. Other alternative approaches to positioning the geometric object may be apparent to those of ordinary skill and such approaches remain in accordance with the scope of the disclosed embodiments.

In an example configuration embodiment, reference points may be selected to simplify the overall bezel compensation configuration process. Therefore, for example, the position of visual object portion 803 is greatly exaggerated for purposed of explanation. That is, the logical coordinates (which may correspond to the display's pixels) of the vertical and horizontal image portion of display (0,0) as shown in FIG. 8, may be fixed as a reference point. Similarly, the upper boundary of display (0,1) may also be fixed in which case only horizontal (i.e. left and right) position adjustments could be made to visual object portion 803. The initial position of visual object 803 would be close to dotted lines 805. That is, the first portion 803 and the second portion 801 (the fixed portion) are initially displayed in a relative orientation adjacent to the common border, between the display to be configured (0,1) and the neighboring display (0,0) where the common border is formed by the bezel of display (0,1) and the bezel of display (0,0) and any space that may exist between the bezels.

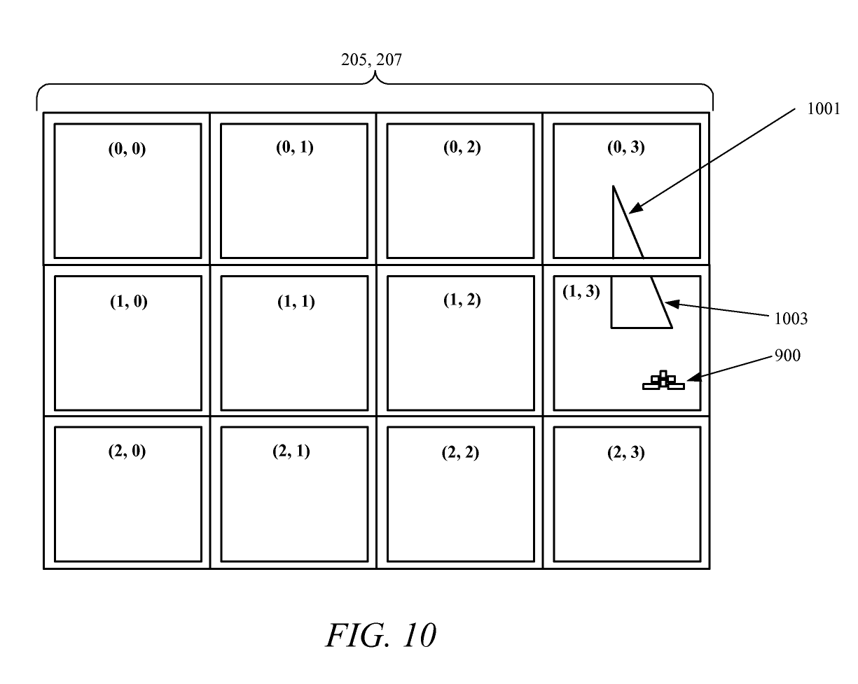

Therefore in some embodiments, which may depend on the number of displays used in the SLS display grid, and also the corresponding arrangement, some of the displays will be initially “fixed” in position such that only the remaining displays need to be configured. For example, in FIG. 10 the upper leftmost display (0,0) may be fixed, since this display may be considered as forming the upper left hand boundary of the overall SLS display. In this case, the first display to be configured may be display (1,0) Display (1,0) may also be “fixed” with respect to its x-coordinate, that is, the leftmost portion of display (1,0) forms part of the outer boundary of the overall SLS display. This may assume alignment of the outer display bezels in some embodiments, but this need not be the case. For configuration of display (1,0) in the example under discussion, the user will align the y-coordinates of the triangle portion to match display (0,0). The process may then proceed to display (0,1), (0,2) and (0,3). As shown in FIG. 10, display (1, 3) is configured with respect to display (0, 3). That is, display (1, 3) is the display to be configured and has a visual test object moveable portion 1003. The neighboring display (0, 3) therefore has a visual text object fixed portion 1001. It is to be understood that, with respect to any particular shape, the “fixed” portion and “moveable” portion are completely geometrically interchangeable. Therefore, in some instances the “point” of the example triangle may be the moveable portion while in other instances the “base” may be the moveable portion. Also, as discussed above displays (0, 3), (1, 3) and (2, 3) (the outermost right column) may be fixed with respect to their logical horizontal or x-coordinate so as to form an outer boundary of the SLS. However, also as discussed above, this need not be the case. Returning to the exemplary configuration, the process continues with displays (1,3), (2,3), (2,2) and (2,1).

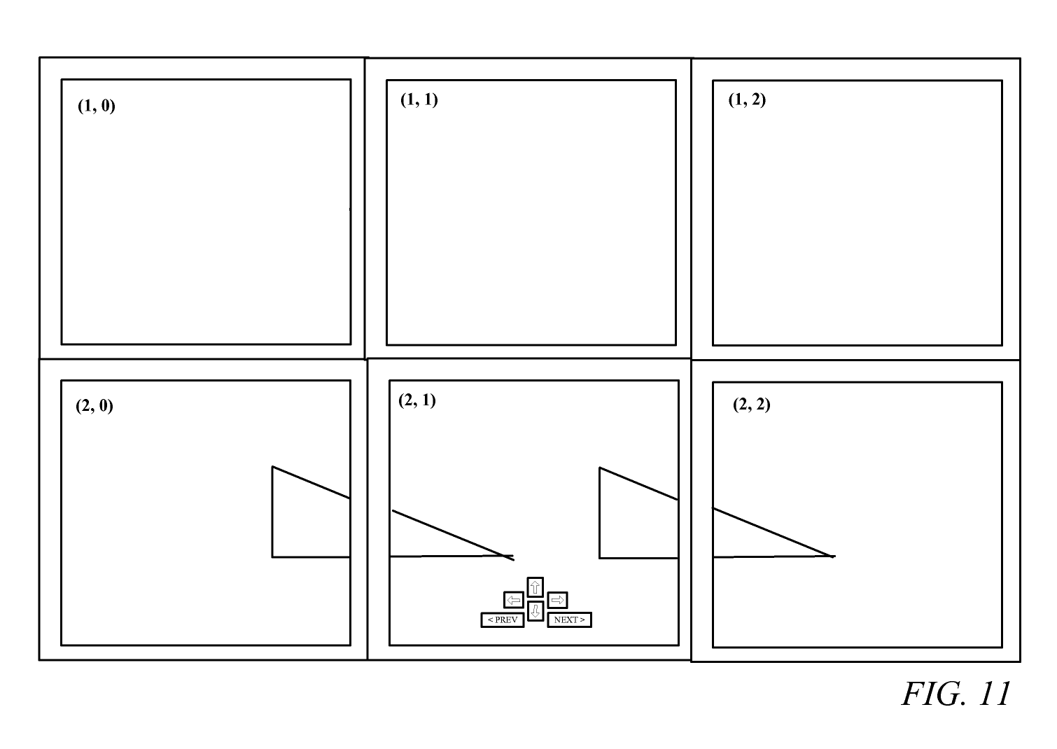

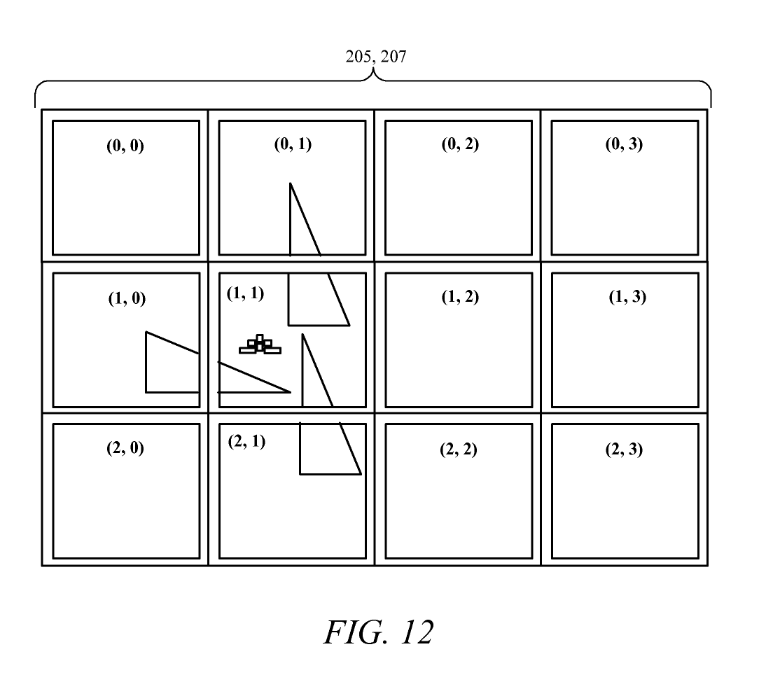

As shown in FIG. 11, display (2,1) must position triangle portions with respect to display (2,0) and display (2,2). FIG. 11 illustrates how the SLS displays appear after the positioning has been completed for display (2,1). The user may then select “NEXT” using the control buttons 900. In accordance with the currently described exemplary embodiment, the configuration process will then proceed to display (1,1) as shown in FIG. 12. That is because, in this example, display (0,0) and (2,0) were “fixed” as forming the outer leftmost boundary of the overall SLS grid. Display (1,0) was the first display configured. Therefore, the process proceeds with display (1,1) FIG. 12 illustrates how the SLS displays appear after the positioning has been completed for display (1,1). The user may then select “NEXT” using the control buttons 900 to proceed to display (1,2) which is the final display to be configured in the current example.

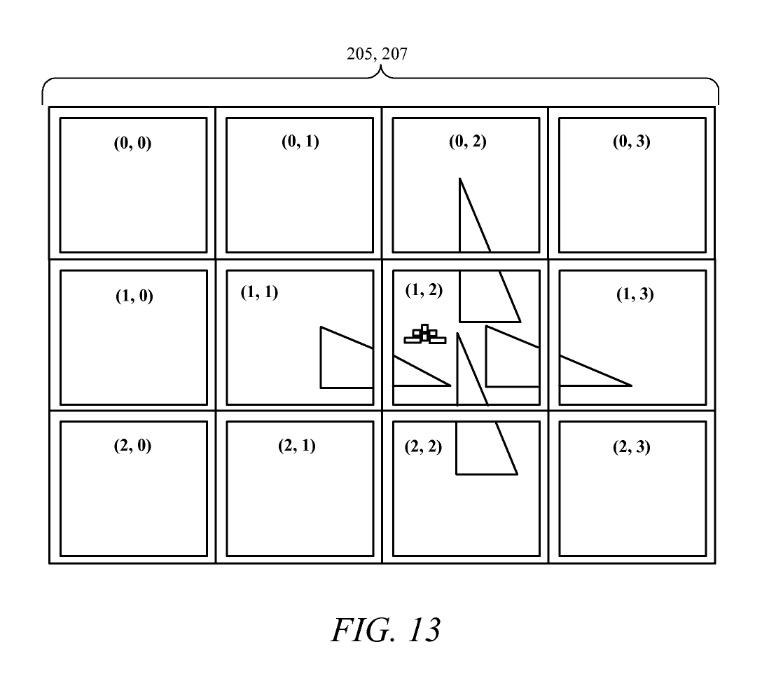

FIG. 13 illustrates how the SLS displays appear after the positioning has been completed for display (1,2). It is to be noted that display (1, 2) requires alignment and positioning with respect to both of its horizontal neighbors, (1,1) and (1,3), and also both of its vertical neighbors, (0,2) and (2,2), since the neighbors are now held fixed as they have already been configured.

Upon completing bezel compensation configuration of the last display, the “NEXT” control button will transform to a “DONE” control button in some embodiments. Selecting “DONE” on the control buttons 900, (or selecting “NEXT” in embodiments where the button does not transform) the bezel configuration wizard will complete storing of the bezel configuration data generated by the user input during the bezel configuration process. The bezel configuration data is stored as the bezel compensation settings 121 illustrated in FIG. 1. The bezel configuration settings will contain x and y-coordinate offsets for each of the configured displays, as well as the initially fixed displays. For example, the data stored for display (0,0) will include the coordinates, “Row=0, Column=0” and the offsets (0,0) indicating that the logical horizontal and vertical coordinates of display (0,0) form the reference corner of the entire SLS. In another example, we assume that display (0, 0) has horizontal and vertical spans of “x: 0 . . . 287” and “y: 0 . . . 239.” (It is to be understood that the numerical values are exemplary only). In that case, if display (0,1) has spans “x: 290 . . . 577” and “y: 0 . . . 239,” then this indicates, in this example, that there is a bezel spacing of 50 between display (0,0) and display (0,1) (i.e. the bezel starts at 240 and ends at 289, and display (0,1) begins at 290). The y-offset for both display (0,0) and (0,1) is zero, since both displays form the uppermost boundary of the overall SLS display grid, and therefore the y-coordinates for these displays was considered fixed. The offset stored for display (0, 1) in this example would be (290, 0) since the viewable area of display (0, 1) on the horizontal begins at 290. By aligning the moveable portion of the virtual test object with the fixed portion of the visual test object, the pixel density “behind” the bezel area is, in effect, being expanded or contracted such that the two visual test object portions align, given the actual pixel density of the display to be configured and its neighboring display.

The method may similarly be applied for any SLS grid configuration having any number of displays. It is to be understood that in the example discussed above, although a right triangle was illustrated in the figures as an example of a visual test object, any appropriate shape or object may be used to configure bezel compensation in accordance with the embodiments. It is believed that a right triangle is an object readily distinguishable by the human eye as being in, or out of, alignment, and that this geometry prevents optical illusions that may occur when using other geometries such as criss-crossed intersecting lines. As a further enhancement to visual perceptibility, the various embodiments may also use a color fill for the geometry. It is believed that a gold color on a black background also aids the user to properly perceive alignment of the geometric shape, such as the right triangle, with minimal optical illusion issues. One such optical illusion example is the “Poggendorff” illusion, and also Zöllner's illusion, in which diagonal lines may appear misaligned when a portion of the lines is hidden behind an object, that is, when the lines end at an object boundary and continue outwardly from the object's adjacent boundary. These example optical illusions are naturally relevant to providing bezel compensation and may pose problems with alignment due to the user's perception.

However, any geometric shape, such as, but not limited to, intersecting lines, single lines, parallel lines, circles, squares, rectangles, polygons, etc., both with or without fill, and, where fill is utilized within the geometric shapes, any appropriate fill pattern and/or any desired fill color, and also using any desired background color or background pattern, may be used by the various embodiments herein disclosed. Combinations of different shapes, patterns, fills, backgrounds, etc., may also be utilized by the various embodiments. Three-dimensional shapes or objects may also be used by the various embodiments, such as but not limited to, three dimensional geometric shapes, characters, etc.

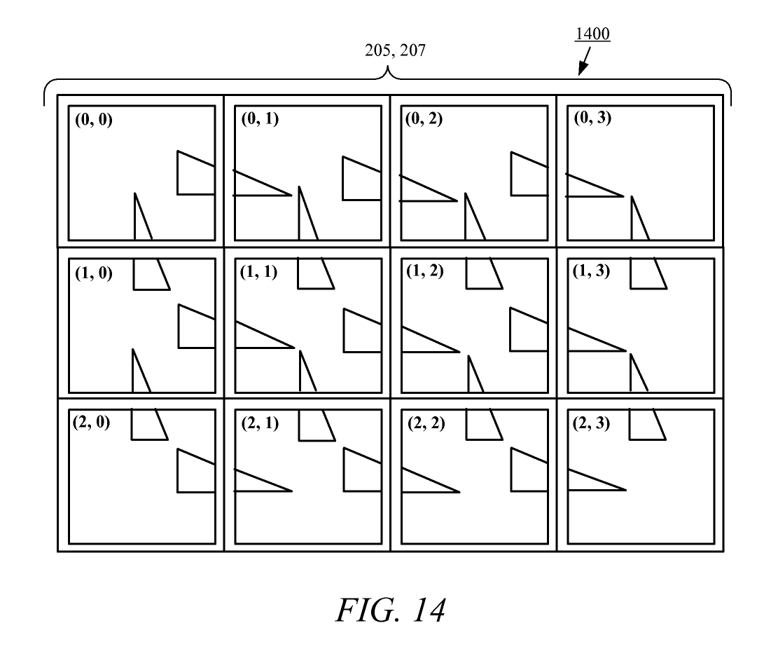

FIG. 14 illustrates a bezel compensation configuration confirmation display 1400 that shows a plurality of visual test objects on each of the individual displays of the SLS so that the user can determine whether the bezel compensation configuration has been satisfactorily completed or whether further editing of the configuration settings is required. The confirmation display 1400 may also have a window accompanying it and displayed on any one of the SLS displays that asks the user whether the appearance of the visual test objects is correct and whether the user wishes to complete configuration or return to the configuration application and edit the settings by proceeding through the process once again.

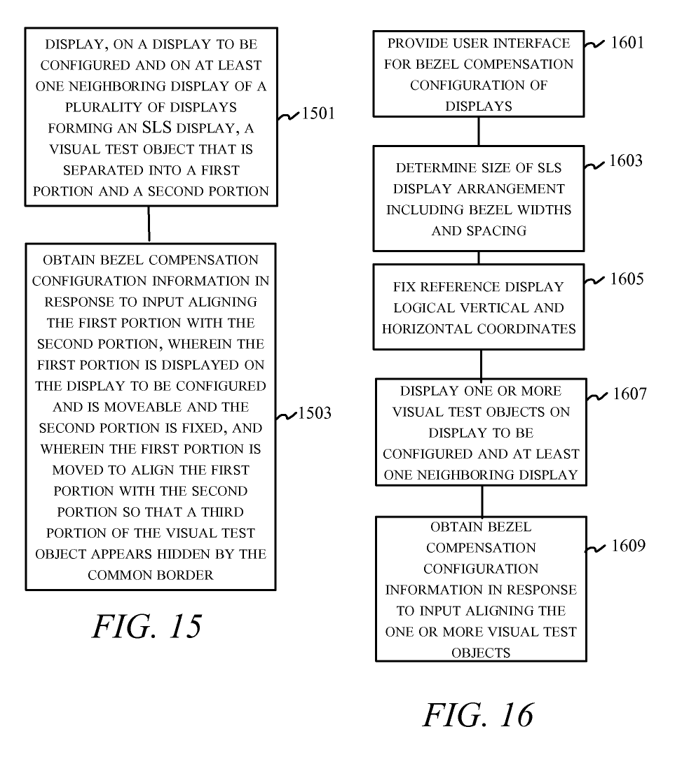

FIGS. 15 through 18 are flowcharts that describe various operations in accordance with the embodiments. For example, FIG. 15 illustrates the overall operation at a high level. In 1501, a visual test object that is separated into a first portion and a second portion, is displayed on a display to be configured and on at least one neighboring display of the SLS displays. This enables a user to perform bezel compensation configuration by aligning the first portion of the visual test object with the second portion of the visual test object. Thus, in 1503, bezel compensation configuration information is obtained in response to input aligning the first portion with the second portion. The first portion of the visual test object is displayed on the display to be configured, and is movable, while the second portion is displayed on one or more neighboring displays and is fixed in position. The first portion is moved to aligned it with the second portion so that a third portion of the visual test object appears hidden by the common border which is formed by the bezels of the display to be configured and its neighboring display.

Turning to FIG. 16, block 1601 shows that the various embodiments provide a user interface for bezel compensation configuration of displays forming an SLS display. Block 1603 illustrates that the bezel compensation logic 117 communicates with the graphics driver/s 127, via the OS 115, to determine the size of the SLS display including bezel widths and heights and any spacing that may exist between the bezels. The height and width of the viewable area of the various displays is obtained by the graphics driver/s 127 which communicates with the physical displays of the SLS and obtains the display capabilities and settings for each display. As was discussed above previously, the graphics driver/s 127 will examine the physical capabilities of the displays, such as for example, but not limited to, display pixel density. Thus in block 1603 the bezel compensation logic 117 has information for of the overall SLS desktop size since the heights and widths, for example in pixels, has been obtained for each individual display making up the SLS display.

This information, which is obtained by bezel compensation logic 117, is also used for determining whether each of the SLS displays are bezel-compensatable. Also, in some embodiments, the bezel heights and widths may be obtained as part of the display information obtained by the graphics driver/s 127 However, some embodiments may use an estimated total height and width of bezels within the SLS area and this estimated total height and width will be determined by the bezel compensation logic 117. For example, the bezel compensation logic 117 may simply use a predetermined value contained within the bezel compensation settings 121. For example, 10% of the SLS overall desktop area, that is 10% of the large desktop area to be displayed on the SOS, may consist of (more particularly, be hidden “behind”) the bezel area. That is, the bezel area effectively “hides” a portion of the desktop image behind the bezels. A user then, during the configuration process, corrects this by adjusting the visual test object accordingly. Block 1605 shows that one of the displays, for example the upper left most corner display, (however any corner of the SLS display may be used as the reference) is selected as a reference display and its logical vertical and horizontal coordinates are fixed by the bezel compensation logic 117. That is, the corner display will no longer be configurable by the user and its vertical an horizontal coordinates will be “fixed.” Further, as shown in 1607, the bezel compensation logic 117 will proceed to display one or more visual test objects on the display to be configured at least one neighboring display. As shown in 1609, the bezel compensation logic 117 will obtain bezel compensation configuration information as a response to input aligning the one or more visual test objects.

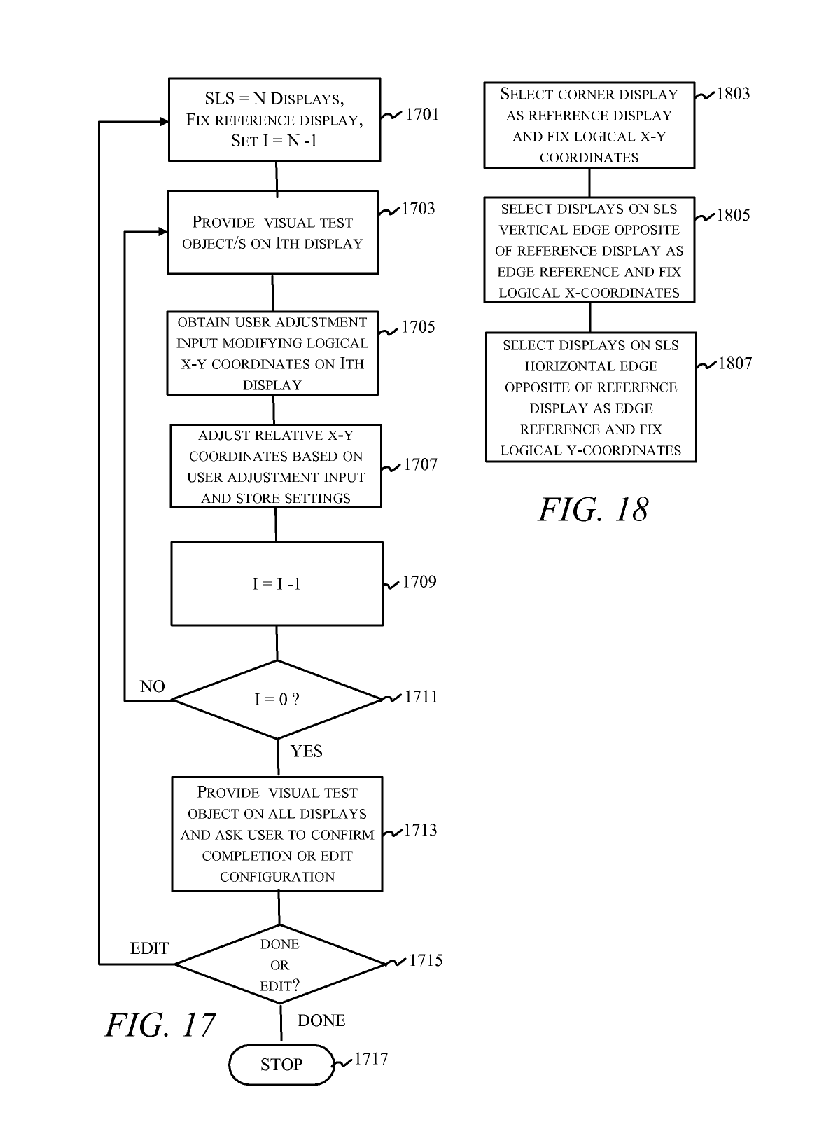

FIG. 17 provides further details of the operation of the various embodiments. Thus, as shown in 1701, an SLS of any number of displays such as “N” displays may be configured for bezel compensation. In 1701, a reference display is selected and its coordinates are fixed. Therefore the number of remaining displays N−1 remain to be configured. Therefore, as shown in 1703, the bezel compensation logic 117 provides visual test objects on the I-th display. User adjustment input modifying the logical x-y coordinates of the I-th display, as shown in 1705, is used by the bezel compensation logic 117 to adjust the relative x-y coordinates of the I-th display with respect to the SLS. Also, in 1707, the settings are stored as bezel compensation settings 121. In 1709 and 1711, if any further displays remain that need to be configured, the process returns to block 1703. However, if no further displays remain, the process will provide visual test objects on all displays of the SLS and prompt the user to confirm completion of bezel compensation configuration, or to otherwise edit the configuration, as shown in 1713. An example of this is illustrated in FIG. 14 which shows a plurality of visual test objects displayed on all displays of the SLS. The user may then select “DONE” or “EDIT,” as shown in 1715, and, if done, the process ends in 1717. If the user selects “EDIT,” the process returns to 1701 and continues through the remaining blocks as described above.

FIG. 18 illustrates that some embodiments, in addition to selecting a corner display as a reference as shown in 1803, may also define various outer perimeter edges of the SLS display. For example, in 1805, a vertical edge is selected as a reference edge. The vertical edge selected may represent a column of displays opposite to, or across from, the reference display. The logical x-coordinates of the displays on this vertical edge (that is the displays forming a column of the SLS) are then fixed with respect to their logical outer edge. Similarly, as shown in 1807, a horizontal edge which may represent a row of displays, also opposite to, or across from, the reference display, may be selected as a reference edge. In this case the y-coordinates of the displays forming the reference edge (that is the reference row) may be fixed. Therefore, the displays that make up the row can only be configured in the horizontal direction (x-direction), that is, left and right.

As was discussed above, with respect to the examples provided, configuration may occur, in accordance with the embodiments, in a generally inward spiral order beginning with a reference display. For example, the top left display may be chosen as a reference and the configuration process may continue in a generally inward clockwise spiral order. Of course, the exact direction of the spiral may be determined by the selected order and need not be clockwise. That is, the order need not be clockwise and a counterclockwise order may be used. As was discussed above with respect to the spiral or generally spiral order, the spiral order may be altered somewhat and may not proceed directly from the selected reference corner display. For example, the display immediately below the top left corner may be configured before the display immediately to the right of the top left corner. That is, the neighboring display in the row immediately below the top left corner display (i.e. display (1, 0)) may be taken out of the exact spiral order and advanced as the first display to be configured. In this example, the top left display of the SLS would be designated as display (0,0) and would not be configurable because it's x-y coordinates would be fixed as the reference display. Then, in this example, the next display to be configured would then be the neighboring display immediately to the right of the top left corner, for example, display (0, 1).

In another embodiment, the right most column of displays, located across from the reference display located at the top left corner, may be selected as defining a reference edge, that is, the right edge of the SLS surface. In this case, all displays in the rightmost column would become effectively tied to the right edge and therefore their x-coordinates would be fixed. Therefore, all displays forming the rightmost column would no longer be configurable in the horizontal (left and right) x-directions. Similarly, a bottom row may be selected as defining the bottom edge of the SLS. In that case, all displays forming the bottom row would become tied to the edge and therefore could no longer be configured in the vertical (up and down) y-directions. This example is illustrated generally by the flowchart of FIG. 18.

Also, in an alternative embodiment to all of the above, a plurality of visual test objects such as illustrated in FIG. 14, may be concurrently displayed on all the displays forming the SLS. In this example embodiment, a user may perform configuration by dragging and dropping the movable portions of each of the plurality of visual test objects similar to the examples described above. A reference display, such as display (0, 0), may also be selected and fixed with respect to its x-y coordinates. Likewise a reference vertical and horizontal edge may be selected and the corresponding coordinates may be fixed for those sets of displays. In any event, the remaining coordinates to be configured, and the remaining movable portions of the visual test objects, would be all be displayed on the SLS at the same time, concurrently. However, the user may be prompted into following the same generally spiral pattern, by an indication of which visual test object to align next and in what order. Some embodiments accomplish this indication by, for example, highlighting around the border display to be configured. Other indications include, but are not limited to, changing the background color of the display to be configured (and its needed configuration neighbors), providing a highlighted border next to the bezel around the border of the viewable area of the display to be configured, etc.

Further, although examples of SLS displays having rectangular arrangements have been discussed, the SLS need not be in a rectangle. That is, the “rectangle” may not be a complete rectangle. One such example, is a cross-pattern having five displays. The top row and bottom row may therefore consist of only a central display, with a middle row of three displays. In other words, the two right and left end displays of the top and bottom rows are “missing” from the rectangle. Such a configuration is still bezel compensation configurable in accordance with the embodiments. Other similar arrangements that may be contemplated by those of ordinary skill are also bezel compensation configurable using the methods and apparatuses of the embodiments herein disclosed.

Therefore the various embodiments herein disclosed are suitable for accommodating various physical arrangements of displays even where multiple graphics processing units are connected to multiple sets of physically arranged displays. Further, although exemplary triangular shapes have been used for purposes of explanation, other visual test object shapes may also be accommodated by the various embodiments herein disclosed. For example, rather than only having a first portion and a second portion, a test object having three or more portions may be used. In this case, the test object may be shown segmented into its multiple portions across multiple displays where “alignment” aligns multiple fixed portions with a moveable central portion displayed on display to be configured. For example, the four triangles shown in FIG. 13 may instead be a geometry or object that appears as a single object portion on display (1, 2) that is configurable in all directions, right, left, up and down.

Therefore methods and apparatuses have been disclosed herein which allow user bezel compensation configuration of single large surface (SLS) displays formed by a plurality of displays. Exemplary embodiments have been described having an apparatus with multiple connector ports for operative connection to a group of six or more displays. A bezel compensation configuration example has been provided for a twenty-four display SLS display. However the embodiments herein disclosed are not to be construed as limited to any particular number of displays. That is, more or less displays may form the SLS display. Further an example of a generally spiral configuration process was described which proceeded from an upper left most top display to an inner display of the SLS. Any of four corners however, could be selected as the initial reference point and therefore the “spiral” may begin at various suitable locations in accordance with the embodiments. Further, the reference display need not be a corner display. Various other “spirals,” arrangements and configurations of displays and/or graphics processing units connected to sets of displays may be envisioned by those of ordinary skill in the art that are contemplated by the embodiments herein disclosed and in accordance with the following claims.

What is claimed is:

1. A method comprising:
displaying, on a display to be configured and on at least one neighboring display of a plurality of displays forming a single large surface display, a visual test object that is separated into a first portion and a second portion, wherein said first portion is displayed on said display to be configured and wherein said second portion is displayed on said at least one neighboring display, and wherein said first portion and said second portion are displayed in a relative orientation adjacent to a common border, between said display to be configured and said at least one neighboring display; and
obtaining bezel compensation configuration information in response to input aligning said first portion with said second portion, and wherein said first portion is moved to align said first portion with said second portion so that a third portion of said visual test object appears hidden by said common border.

2. The method of claim 1, comprising:
displaying an alignment control for aligning said first portion with said second portion; and
adjusting relative vertical and horizontal logical coordinates of said display to be configured's viewable area based on said bezel compensation configuration information, and in response to said first portion of said visual test object being moved using said alignment control.

3. The method of claim 1, comprising:
adjusting relative vertical and horizontal logical coordinates of said display to be configured's viewable area based on said bezel compensation configuration information, and in response to said first portion of said visual test object being moved using a drag-and-drop technique.

4. The method of claim 1, wherein displaying, on a display to be configured and on at least one neighboring display of a plurality of displays forming a single large surface display, a visual test object that is separated into a first portion and a second portion, comprises:
displaying a right triangle as said visual test object.

5. The method of claim 4, comprising:
displaying said right triangle having a colored fill and being displayed on a black background on said display to be configured and on said at least one neighboring display.

6. The method of claim 1, comprising:
obtaining, as input, width and height dimensions of said single large area surface (SLS) display to be formed by said plurality of displays;
obtaining, as input, approximate height and width dimensions of total bezel heights and widths for said plurality of displays; and
fixing vertical and horizontal logical coordinates of at least one reference display within the SLS display based on the approximate width and height dimensions.

7. The method of claim 6, wherein obtaining, as input, approximate height and width dimensions of total bezel heights and widths for said plurality of displays, comprises:
obtaining total bezel heights and widths including any spaces between bezels of neighboring displays within said single large area surface display.

8. The method of claim 6, wherein fixing vertical and horizontal logical coordinates of at least one reference display within the SLS display based on the approximate width and height dimensions, comprises:
fixing vertical and horizontal coordinates of a reference display in a corner of a rectangular arrangement wherein said plurality of displays forming said SLS display are arranged in said rectangular arrangement.

9. The method of claim 8, further comprising:
determining a set of displays to be configured selected from said plurality of displays forming said SLS display, and displaying one or more visual test objects, on each display to be configured of said set of displays, for each display to be configured one-by-one, sequentially proceeding in a sequence to a next display to be configured after completion of configuration of a previous display to be configured, wherein said sequence follows an approximately spiral pattern proceeding from a display at an outer perimeter of said rectangular arrangement to a final innermost display that is innermost of said rectangular arrangement.

10. The method of claim 1, wherein said common border is formed by a first bezel of said display to be configured and a second bezel of said at least one neighboring display.

11. The method of claim 1, wherein said first portion displayed on said display to be configured is moveable and said second portion is fixed.

12. A method comprising:
obtaining width and height dimensions of a single large area surface display to be formed by a plurality of displays;
obtaining approximate height and width dimensions of the total bezel heights and widths for said plurality of displays;
providing, by bezel compensation configuration logic, displayable information to a display to be configured and to at least one neighboring display of said plurality of displays forming said single large surface display, wherein said displayable information is for displaying a visual test object that is separated into a first portion and a second portion, wherein said first portion is to be displayed on said display to be configured and wherein said second portion is to be displayed on said at least one neighboring display, and wherein said first portion and said second portion are to be displayed in a relative orientation across a border formed by a first bezel of said display to be configured and a second bezel of said at least one neighboring display; and
obtaining configuration information based on input aligning said first portion with said second portion.

13. An apparatus comprising:
at least one processor; and
memory operatively coupled to said processor, wherein said memory contains instructions for execution by said at least one processor, wherein said at least one processor, upon executing said instructions is operable to:
provide displayable information for a display to be configured and for at least one neighboring display of a plurality of displays forming a single large surface display, said displayable information including a visual test object that is separated into a first portion and a second portion, wherein said first portion is for display on said display to be configured and wherein said second portion is for display on said at least one neighboring display, and wherein said first portion and said second portion are displayed in a relative orientation adjacent to a common border between said display to be configured and said at least one neighboring display; and
obtain bezel compensation configuration information in response to input aligning said first portion with said second portion, and wherein said first portion is moved to align said first portion with said second portion so that a third portion of said visual test object appears hidden by said common border.

14. The apparatus of claim 13, wherein said at least one processor, upon executing said instructions is operable to:
provide displayable information for displaying an alignment control for aligning said first portion with said second portion; and
adjust relative vertical and horizontal logical coordinates of said display to be configured's viewable area based on said bezel compensation configuration information, and in response to said first portion of said visual test object being moved using said alignment control.

15. The apparatus of claim 13, further comprising:
said display to be configured and said at least one neighboring display, operatively coupled to said at least one processor, wherein said display to be configured and said at least one neighboring display are operative to:
receive said displayable information from said at least one processor and display said visual test object.

16. The apparatus of claim 13, wherein said at least one processor, upon executing said instructions is operable to:
adjust relative vertical and horizontal logical coordinates of said display to be configured's viewable area based on said bezel compensation configuration information, and in response to said first portion of said visual test object being moved using a drag-and-drop technique.

17. The apparatus of claim 15, wherein said at least one processor, upon executing said instructions is operable to:
provide displayable information to said display to be configured, and to said at least one neighboring display, for displaying a right triangle as said visual test object.

18. The apparatus of claim 17, wherein said at least one processor, upon executing said instructions is operable to:
provide displayable information to said display to be configured, and to said at least one neighboring display, for displaying said right triangle having a colored fill and being displayed on a black background.

19. The apparatus of claim 13, wherein said at least one processor, upon executing said instructions is operable to:
obtain, as input, width and height dimensions of said single large area surface (SLS) display to be formed by said plurality of displays;
obtain, as input, approximate height and width dimensions of total bezel heights and widths for said plurality of displays; and
fix vertical and horizontal logical coordinates of at least one reference display within the SLS display based on the approximate width and height dimensions.

20. The apparatus of claim 19, wherein said at least one processor, upon executing said instructions is operable to:
obtain total bezel heights and widths including any spaces between bezels of neighboring displays within said single large area surface display.

21. The apparatus of claim 19, wherein said at least one processor, upon executing said instructions is operable to:
fix said vertical and horizontal logical coordinates of at least one reference display within the SLS display based on the approximate width and height dimensions, by fixing vertical and horizontal coordinates of a reference display in a corner of a rectangular arrangement wherein said plurality of displays forming said SLS display are arranged in said rectangular arrangement.

22. The apparatus of claim 13, wherein said at least one processor, upon executing said instructions is operable to:
determine a set of displays to be configured selected from said plurality of displays forming said SLS display, and provide displayable information for displaying one or more visual test objects, on each display to be configured of said set of displays, for each display to be configured one-by-one, sequentially proceeding in a sequence to a next display to be configured after completion of configuration of a previous display to be configured, wherein said sequence follows an approximately spiral pattern proceeding from a display at an outer perimeter of said rectangular arrangement to a final innermost display that is innermost of said rectangular arrangement.

23. The apparatus of claim 13, wherein said common border is formed by a first bezel of said display to be configured and a second bezel of said at least one neighboring display.

24. The apparatus of claim 13, wherein said first portion displayed on said display to be configured is moveable and said second portion is fixed.

25. A computer readable memory comprising:
executable instructions for execution by at least one processor, that when executed cause said at least one processor to:
provide displayable information for a display to be configured and for at least one neighboring display of a plurality of displays forming a single large surface display, said displayable information including a visual test object that is separated into a first portion and a second portion, wherein said first portion is for display on said display to be configured and wherein said second portion is for display on said at least one neighboring display, and wherein said first portion and said second portion are displayed in a relative orientation adjacent to a common border, between said display to be configured and said at least one neighboring display; and
obtain bezel compensation configuration information in response to input aligning said first portion with said second portion, and wherein said first portion is moved to align said first portion with said second portion so that a third portion of said visual test object appears hidden by said common border.

26. The computer readable memory of claim 25, wherein said executable instructions, when executed further cause the at least one processor to:
provide displayable information for displaying an alignment control for aligning said first portion with said second portion; and
adjust relative vertical and horizontal logical coordinates of said display to be configured's viewable area based on said bezel compensation configuration information, and in response to said first portion of said visual test object being moved using said alignment control.

27. The computer readable memory of claim 25, wherein said executable instructions, when executed further cause the at least one processor to:
adjust relative vertical and horizontal logical coordinates of said display to be configured's viewable area based on said bezel compensation configuration information, and in response to said first portion of said visual test object being moved using a drag-and-drop technique.

28. The computer readable memory of claim 25, wherein said executable instructions, when executed further cause the at least one processor to:
provide displayable information to said display to be configured, and to said at least one neighboring display, for displaying a right triangle as said visual test object.

29. A method comprising:
displaying, on a single large surface display, a first moveable portion and second fixed portion of a visual test object wherein the first portion is displayed on a display to be configured and the second portion is displayed on at least one neighboring display, and wherein said first portion and said second portion are shown in a relative orientation adjacent to a common border formed by a first bezel of the display to be configured and a second bezel of the at least one neighboring display; and
obtaining bezel compensation configuration information in response to input aligning the first portion with the second portion.

30. An apparatus comprising:
at least one processor; and
memory operatively coupled to said processor, wherein said memory contains instructions for execution by said at least one processor, wherein said at least one processor, upon executing said instructions is operable to:
provide a bezel compensation configuration graphical user interface (GUI) for display on a plurality of displays forming a single large area surface (SLS), said GUI including a visual test object having a first portion and a second portion, wherein the first portion is moveable on a first display to align with said second portion located on a neighboring reference display across a border between said neighboring reference display and said first display.

31. The apparatus of claim 30, wherein said GUI further includes:
an alignment control for aligning said moveable portion with said fixed portion.

32. The apparatus of claim 31, wherein said GUI further includes:
an indication that guides a user from a first display to be configured through, display-by-display, to a final display to be configured.
